(19) United States
(12) Patent Application Publication
(10) Pub. No.: US 2006/0153640 A1
(43) Pub. Date: Jul. 13, 2006

(54) Sewer pipe

(75) Inventor: Frank Hofmann, Attendorn-Helden (DE)

Correspondence Address: HENRY M FEIEREISEN, LLC, 350 FIFTH AVENUE, SUITE 4714, NEW YORK, NY, 10118, US

(73) Assignee: Tracto-Technik GmbH, 57368 Lennestadt (DE)

(21) Appl. No.: 10/540,988

(22) PCT Filed: Dec. 22, 2003
(86) PCT No.: PCT/EP03/14738

§ 371 Date: Jan. 20, 2006

(30) Foreign Application Priority Data
Dec. 28, 2002 (DE) 102613346

(51) Int. Cl. F16L 55/18

(52) U.S. Cl. 405/184.1

(57) ABSTRACT

A sewer pipe (30) comprising partial pipe shells (31, 32) placed on one another and connecting means (33) connecting the partial pipe shells (31, 32) firmly to each another. A laying method for the sewer pipe, in which the end of the sewer pipe is connected to a boring device and is drawn into the ground by means of the boring device.

The invention relates to a sewer pipe, in particular a sewer pipe for use in a horizontal boring method.

Sewer pipes are introduced into the ground in multifarious forms and with different laying methods. Since sewer pipes were initially laid in open sewer construction, increasingly sewer pipes are now introduced into the ground in what is known as the trenchless laying method. For this purpose, the sewer pipe is, for example, rammed directly into the ground or drawn into the ground by a boring device. In this case, the sewer pipe can be drawn into an existing pilot bore or an old sewer to be replaced, by using an expanding head.

The boring heads used in trenchless laying regularly have connecting lines with which, for example, a boring liquid to be discharged at the boring head is led to the boring head or, for example, a pressure medium driving the boring head in a percussive manner is supplied to the boring head.

As a rule, during trenchless pipe laying, the pipe to be laid is introduced into the ground from a starting excavation. In order to keep the dimensions of the starting excavation to be removed as small as possible, it is known to assemble the sewer pipe from short pipe sections, which can be connected to one another in a tension-proof manner in order to form the sewer pipe. In order to introduce it into the ground, the respective pipe section is positioned in the starting excavation and drawn or pushed into the ground. Thus, the dimensions of the starting excavation depend virtually completely on the length of the respective pipe section.

If the sewer pipe assembled from pipe sections is introduced into the ground by a boring head, in particular an expanding head, and if this boring head has hose lines connected to it, then in the past, for the purpose of efficient introduction of the sewer pipe, first of all each pipe section had to be drawn onto the hose lines, in order that, during the introduction of the next pipe section, the hose lines did not have to be separated. The disadvantage here is that, during the entire boring operation, the pipes threaded onto the hose lines have to be dragged along as well. To some extent, this carrying along of the pipe sections threaded loosely onto the hose lines leads to the loose pipe sections striking one another and, as a result, damage being caused to the pipe sections. Furthermore, a device is necessary in order to connect the pipe section in each case to be introduced next to the pipe section already introduced before it, in order that the pipe section already drawn in can draw into the ground the pipe section to be drawn in. These connecting devices load the pipe sections highly and can likewise lead to damage to the pipe sections. Furthermore, separate means are necessary to keep the pipe sections joined together to form a pipe string together on the boring device, in order that the assembly is not detached as it is drawn into the ground.

In addition, the laying of a sewer pipe in accordance with the conventional method is very time-consuming; in particular since the individual pipe sections firstly have to be threaded onto the hose.

Against this background, the invention is based on the object of proposing a sewer pipe which can be introduced into the ground in a straightforward manner.

This object is achieved by the subject matter of the independent claims. Advantageous refinements are specified in the subclaims.

The invention is based on the basic idea of assembling the pipe from part sections based on the pipe circumference. In this way, the pipe can be placed directly at the desired location around an object intended to lead through the sewer pipe, in particular a hose line. Since the sewer pipe now does not have a closed circumference from the start, it is no longer necessary to push the sewer pipe or the small sewer pipes (pipe sections) forming a sewer pipe onto the element leading through the sewer pipe.

In particular, the sewer pipe has partial pipe shells which are placed on one another and connected firmly to one another by connecting means. In this case, in a sewer pipe, at least one of the connecting means for connecting the partial pipe shells forming the circumference of the sewer pipe is preferably designed to be detachable, in order that the circumference of the sewer pipe can be opened to bring the sewer pipe into a position embracing an object.

Within the scope of this invention, a sewer pipe is understood in particular to mean any elongated body which can be introduced into the ground. In this case, the sewer pipe is preferably a hollow body, in particular a hollow cylindrical body. However, the sewer pipe can also have a cross section deviating from a cylindrical cross section, for example a rectangular or elliptical cross section. The sewer pipe is preferably designed as a wastewater pipe, cable duct, district heating pipe or a gas pipe. Furthermore, in further specific configurations, the sewer pipe is designed as a protective pipe for the supply lines of a boring device or as a drainage pipe.

Partial pipe shells are understood to mean in particular any elements which can be placed on one another in order to form the circumference of a sewer pipe. In this case, the partial pipe shells are preferably elongated shells curved transversely with respect to the longitudinal direction, which can be assembled at their longitudinal edges to form a pipe. In this case, the partial pipe shells can have identical dimensions or else can be designed differently from one another. The sewer pipe is particularly preferably assembled from two half pipe shells.

Connecting means are understood in particular to mean any means which are suitable for connecting partial pipe shells to one another to form a sewer pipe. These can be tires or bands which embrace the assembled sewer pipe, screw clamps acting on ledges on the partial pipe shells, screw connections engaging in corresponding threads in a partial pipe shell. The connecting means can connect the partial pipe shells nondetachably firmly to one another following the assembly of the sewer pipe, for example by means of jointing methods, or by the fact that the connecting means are already produced during the production of the partial pipe shells as a connection produced in one piece with the partial pipe shells, for example by original forming, for example a casting method.

In an advantageous refinement of the invention, at least two partial pipe shells are connected to each other via a hinge. This firm connection of the partial pipe shells leads to the partial pipe shells connected to each other in such a way being able to be transported and handled together. Furthermore, the hinge offers the possibility of laying the partial pipe shells simply around the object to be led through the sewer pipe. The hinge can already be produced during the manufacture of the partial pipe shells, for example by means of original forming, for example casting, manufactured in one piece with the partial pipe shells to be connected via the hinge. As a result, the hinge produces a permanent connection between the partial pipe shells. The hinge can also comprise components which are manufactured in one piece with the partial pipe shells and which are connected to form an easily detachable hinge, for example by means of a plug-in mechanism. As a result, the partial pipe shells can be handled individually and therefore more easily during transport, while the loadable connection formed by the detachable hinge can easily be produced at the point of use.

A simple connection of the partial pipe shells is provided by at least one latching element. The latching element preferably latches into a recess in the other partial pipe shell to be connected to the one partial pipe shell. In this case, latching element is understood to mean in particular any element which can produce a latching action, that is to say for example a depression which can latch in a protrusion of the element to be connected by latching.

Recess is understood in particular to mean the mating piece corresponding to the latching element, which is formed in such a way that a latching element can produce a latching action on it. In particular, the recess is a depression in the outer surface of the one element, behind which a projection of the latching element engages. Recess is also understood, for example, to mean a hole, in which a latching element, for example formed in the manner of a barb, can engage.

The partial pipe shell can have a single latching element. In a preferred refinement, the latter is formed as an elongated latching band. However, the partial pipe shell can also have a large number of latching elements, for example latching pins reaching through latching holes. A latching pin can be, for example, a cylindrical body or else a flat narrow strip.

The latching element is preferably pivotably connected to the partial pipe shell, in order in this way to permit more flexible handling of the latching element. In particular, the latching element can be pivotably connected to a partial pipe shell by a hinge, preferably formed in one piece with the partial pipe shell.

In order to simplify the joining of the partial pipe shells, a partial pipe shell preferably has positioning aids, in particular positioning pins, which engage in positioning recesses in a further partial pipe shell. A positioning aid is in particular a stationary, freestanding element of a partial pipe shell which, by means of the interaction with a recess in another partial pipe shell, effects positioning of the one partial pipe shell with respect to the other partial pie shell when the partial pipe shells are placed on each other.

The partial pipe shells can be configured such that the sewer pipe assembled from partial pipe shells is suitable to be connected at the ends to further sewer pipes or a boring device. In particular, means for transmitting tensile forces are provided for this purpose.

In a preferred refinement, at least one partial pipe shell has a recess in the inner surface. This recess can accommodate an elevation which is provided on the element to which the sewer pipe is to be connected.

A preferred refinement of the partial pipe shell provides for at least one elevation to be provided at the end on the outer surface, in particular at the end opposite the recess in the inner surface. A sewer pipe which has at least one such partial pipe shell is itself suitable to be connected to further sewer pipes. In this way, a pipe string can be formed from the individual sewer pipes, in that the respective one sewer pipe engages around the end of the respective other sewer pipe, the elevation at the end of the one sewer pipe engaging in the recess at the end of the other sewer pipe.

To connect the sewer pipe to other elements, in particular to a boring device or further sewer pipe, latching elements can be provided on the outer side of the partial pipe shell and on the inner side of the partial pipe shell and, when the sewer pipe provided with such a partial pipe shell is pushed onto a further element, forms a connection that transmits tensile forces. In particular, the latching elements provided on the outer or inner side engage in latching elements which are provided on the element to which the sewer pipe is to be connected. The sewer pipe preferably has latching elements on the outer side at one end, while it has latching elements on the inner side at the other end. As a result, individual sewer pipes can be connected firmly to one another by being pushed into one another.

A sewer pipe string according to the invention has at least one previously described sewer pipe connected to further sewer pipes and a seal arranged between the sewer pipes. In particular, an O ring can be provided, which seals off the one pipe assembled from partial pipe shells with respect to an adjacent pipe.

In order to be able to serve as a transport means for fluids, an advantageous refinement of the sewer pipe according to the invention has sealing elements arranged between the partial pipe shells. Here, the sealing elements can in particular be provided on the contact surfaces of the partial pipe shells placed on one another and in a recess provided in the partial pipe shells. The sealing elements can be separate sealing bodies inserted into recesses. Additionally or alternatively, the partial pipe shells can be formed in such a way that, when joined together, they produce a sealing action, for example by means of a pinch seal. For this purpose, the positioning aid, in particular a positioning edge, can be formed in such a way that it engages in a groove in a further partial pipe shell.

The sewer pipe can be produced at least partly from plastic. In particular, the latching elements connecting the partial pipe shells are produced from plastic. As a result, these have the necessary flexibility to be able to produce the latching action simply. Furthermore, this material selection offers the advantage that the partial pipe shells can be produced by the injection molding process. In particular, a sewer pipe which has partial pipe shells, which are already connected to each other by film hinges during manufacture, and which has latching elements on only one side in order to connect two partial pipe shells, can be produced in a one piece.

In order that the sewer pipe can withstand the loadings acting during the introduction into the ground and after being laid in the ground, it is preferably reinforced with glass fibers.

The sewer pipe according to the invention can be connected at the end to a boring device and drawn into the ground by means of the boring device. In this case, boring device is understood to mean any device which is suitable to draw a sewer pipe into the ground. In particular, these are self-propelled boring devices, impact boring devices or expanding heads driven forward by means of pull cables or thrust linkages.

A system according to the invention comprising partial pipe shells is formed in such a way that the partial pipe shells can be assembled to form a pipe with partial pipe shells placed on one another in relation to the pipe circumference and which can be firmly connected to one another by connecting means. This system of partial pipe shells can be handled easily as compared with a closed pipe.

A sewer pipe string having at least one previously described sewer pipe is produced in accordance with a method according to the invention in that the partial pipe shells forming a first sewer pipe are put in place so as to embrace the end of a second sewer pipe and are firmly connected to one another by the connecting means. In particular, at least two partial pipe shells connected by a hinge are put in place so as to embrace the end of the second sewer pipe and are folded together.

The sewer pipe according to the invention can be used for the purpose of forming a longer sewer line with further sewer pipes. To this end, after the first sewer pipe has been drawn in, a second sewer pipe is connected to the free end of the first sewer pipe and this second sewer pipe is then drawn into the ground into the first sewer pipe by means of the boring device. This can be done in particular from a starting excavation. Likewise, however, the sewer pipe can be drawn into the ground from the surface of the ground.

In order to be connected to the boring device or to a sewer pipe already introduced, the sewer pipe to be introduced is preferably assembled from partial pipe shells immediately before the introduction into the ground. This prevents the sewer pipe to be introduced having to be threaded onto a hose line, for example, and having to be handled with the hose line. Furthermore, assembly carried out immediately before the introduction offers the advantage that the sewer pipe to be introduced can be handled in narrower part sections. For example, a pipe with a large cross section can be put through smaller openings, for example manholes, in pieces and only then assembled. Furthermore, the partial pipe shells can be transported better, in particular with less transport space, as compared with an existing sewer pipe with a fixed circumference.

Furthermore, the sewer pipe according to the invention can be rammed into the ground by means of a ramming device.

In the following text, the invention will be explained in more detail by using an exemplary embodiment illustrated in the drawing, in which:

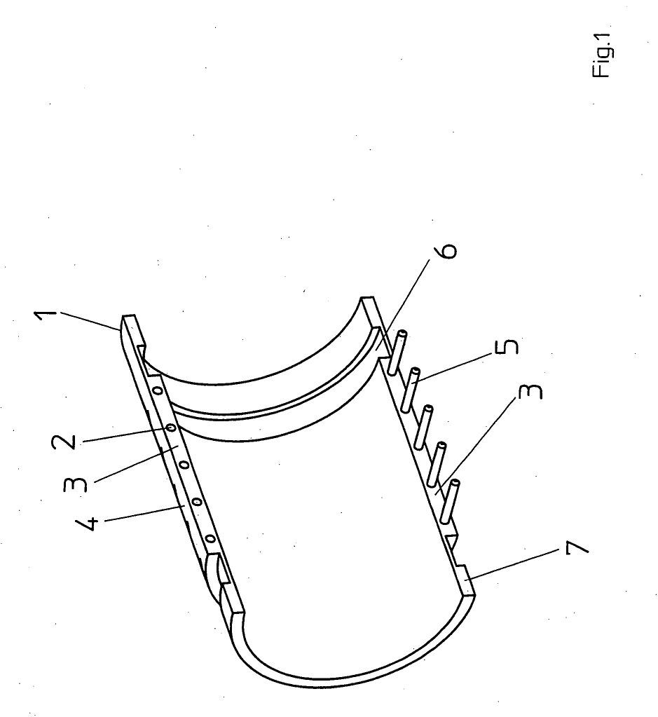

FIG. 1 shows a partial pipe shell of a sewer pipe according to the invention in a perspective view,

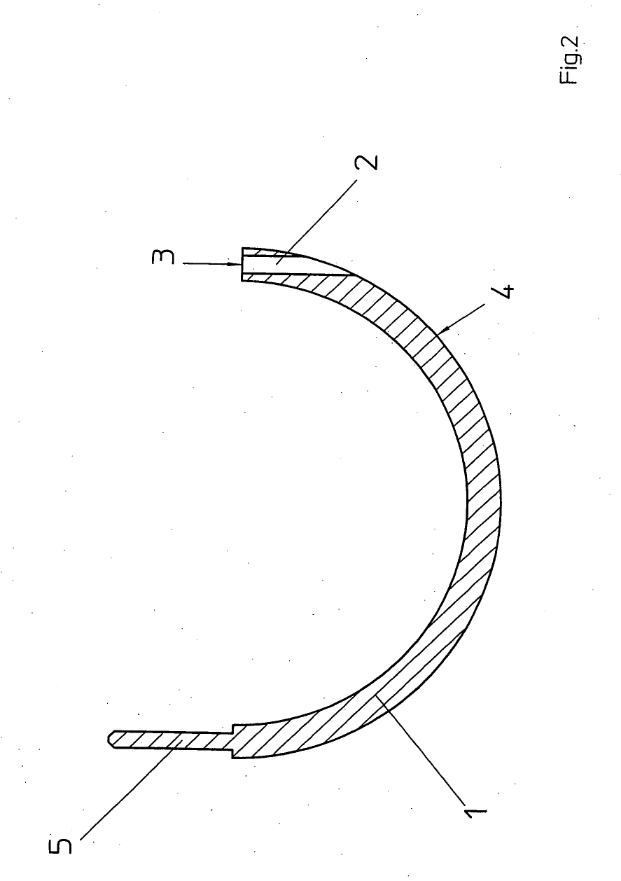

FIG. 2 shows the partial pipe shell according to FIG. 1 in a sectioned illustration,

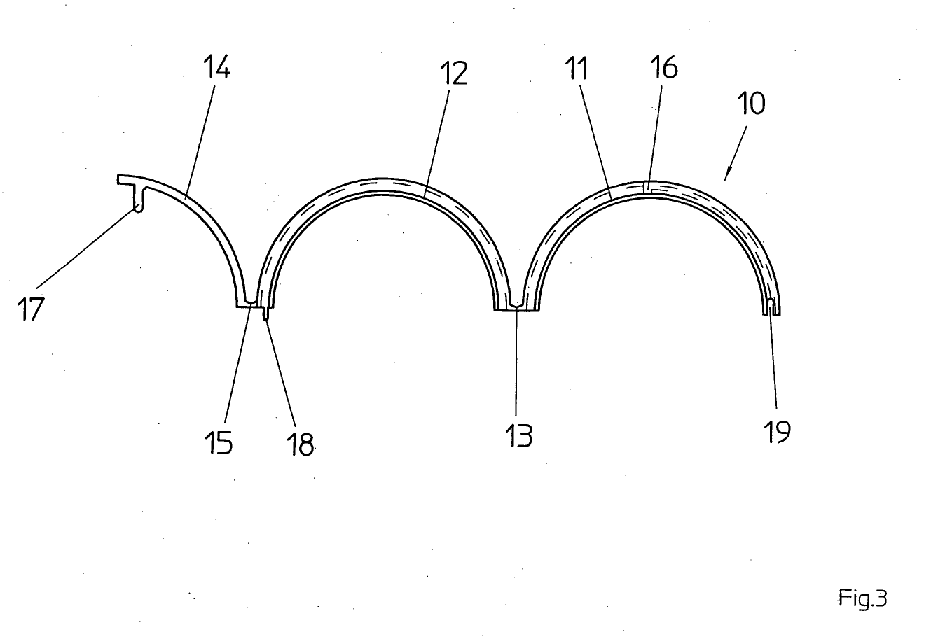

FIG. 3 shows a further sewer pipe according to the invention in a cross section,

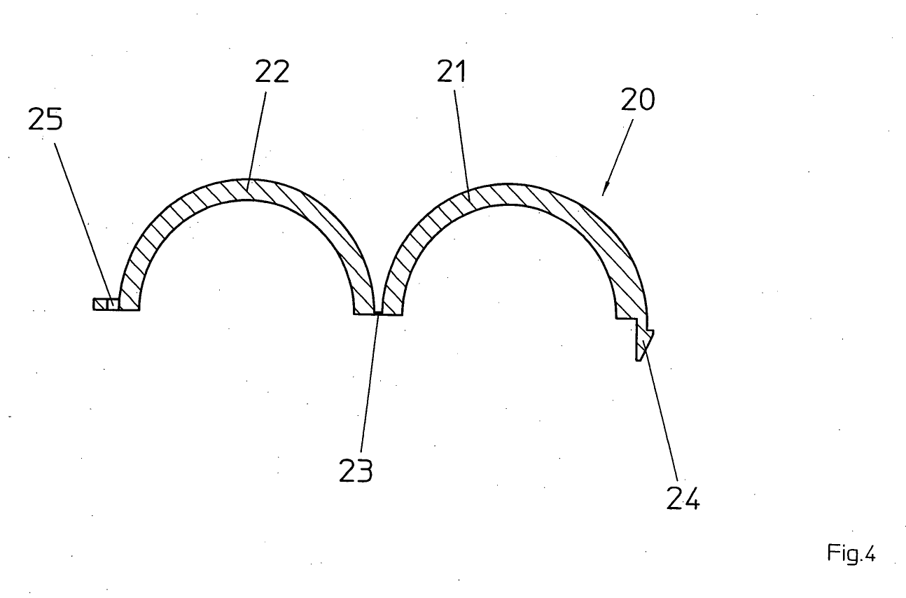

FIG. 4 shows a third sewer pipe according to the invention in a cross section, and

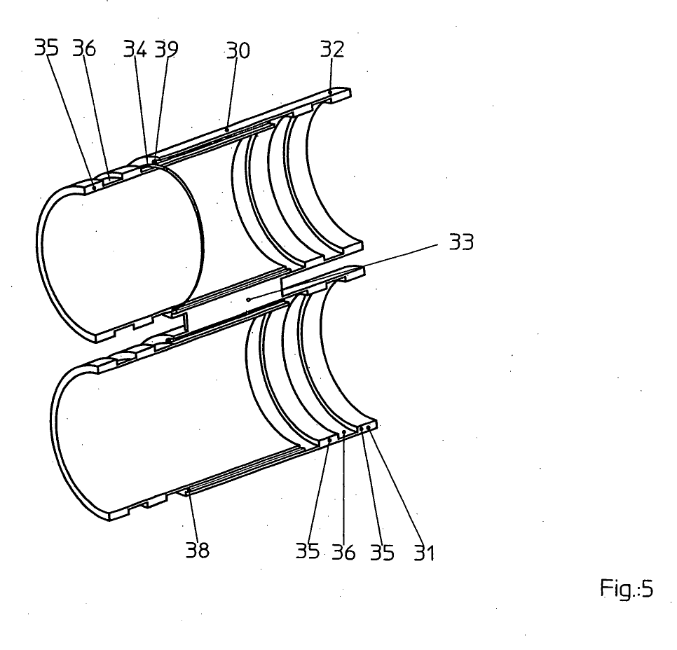

FIG. 5 shows a fourth sewer pipe according to the invention in a perspective view.

The partial pipe shell 1 illustrated in FIG. 1 is a half pipe shell, which can be assembled by being placed on a second partial pipe shell of identical construction to form a sewer pipe. The partial pipe shell has latching holes 2, which lead from the contact surface 3 to the outer surface 4 of the partial pipe shell 1. Latching pins 5 are provided on a second contact surface 3. These are suitable to interact with the latching holes 2 of the second partial pipe shell, not illustrated, in order to connect the partial pipe shells firmly to each other and therefore to produce a rigid sewer pipe.

The partial pipe shell 1 has a recess 6 at the end. An elevation 7 is provided at the opposite end of the partial pipe shell. The recess 6 is suitable to accommodate the elevation 7 of a further partial pipe shell or a boring device and, after the partial pipe shells have been put together, to produce a connection transmitting tensile force between the two sewer pipes or between the sewer pipe and the boring device.

The sewer pipes 10, 20 illustrated in FIGS. 3 and 4 are produced in one piece. They have partial pipe shells 11, 12, 21, 22, the partial pipe shells 11 and 12 and the partial pipe shells 21 and 22 being connected firmly to each other via film hinges 13 and, respectively, 23. As a result of the film hinges 13, 23, there is a pivoting connection between the partial pipe shells 11, 12 and the partial pipe shells 21, 22, which makes it possible to fold the partial pipe shell 12 onto the partial pipe shell 11 and to fold the partial pipe shell 22 onto the partial pipe shell 21.

The sewer pipe 10 illustrated in FIG. 3 has a latching element 14 which is formed as elongated latching band. This latching element 14 is connected to the partial pipe shell 12 via a further film hinge 15. The latching element 14 has a hook 17, which can engage in a recess 16 in the partial pipe shell 11 when the partial pipe shell 12 is folded onto the partial pipe shell 11 and the latching element 14 is brought into contact with the outer surface of the partial pipe shell 11.

Furthermore, the sewer pipe 10 has a positioning aid in the form of a positioning edge 18, which can engage in a positioning recess 19 in the partial pipe shell 11. This positioning aid ensures that the partial pipe shells 11 and 12 can be connected to each other quickly and in a targeted manner. In addition, the positioning edge 18 performs the function of a pinch edge which, in interaction with a pinch seal (not illustrated) inserted into the positioning recess 19, seals off the pipe to be formed in the radial direction.

The sewer pipe 20 has a latching element 24 which is formed so as to be fixed to the partial pipe shell 22 and which can engage in a latching hole 25 formed on the outer side of the partial pipe shell 22.

The sewer pipe 30 illustrated in FIG. 5 comprises partial pipe shells 31, 32, which are connected to each other via a hinge 33. On the free long sides, the partial pipe shell 31 has a positioning aid in the form of a positioning edge 38, which can engage in a positioning recess 39 in the partial pipe shell 32. As a result, a pinch seal is formed. Also illustrated in FIG. 5 is an O ring 34, which seals off the sewer pipe 31 illustrated with respect to a further sewer pipe (not illustrated). For the purpose of a connection to a further sewer pipe that is resistant to tension and thrust, the sewer pipe 30 has elevations 35 and recesses 36 on the outer surface. Furthermore, recesses 36 and elevations 35 are formed on the inner surface. These recesses 36 and elevations 35 interact with recesses and elevations of the further sewer pipe, not illustrated. For this purpose, the end of the sewer pipe is put in place so as to embrace the end of the further sewer pipe, and the partial pipe shells 31 and 32 are folded together.

1. A sewer pipe, comprising partial pipe shells; and connecting means connecting the partial pipe shells firmly to one another.

2. The sewer pipe as claimed in claim 1, wherein at least two of the partial pipe shells are connected to each other via a hinge.

3. The sewer pipe as claimed in claim 1, wherein at least two of the partial pipe shells are connected via a latching element which is provided on the one of the two partial pipe shell shells for latching into a recess in the other one of the two partial pipe shell shells.

4. The sewer pipe as claimed in claim 3, wherein the latching element is a latching pin engages in the recess in the form of a latching hole in the other one of the partial pipe shells.

5. The sewer pipe as claimed in claim 3, further comprising a hinge for pivotably connecting the latching element to one of the partial pipe.

6. The sewer pipe as claimed in claim 1, wherein one of the one of the partial pipe shells has a positioning pin for engagement in a positioning recess in a further one of the partial pipe shells.

7. The sewer pipe as claimed in claim 1, wherein at least one of the partial pipe shells has an inner surface formed with a recess at the an end thereof.

8. The sewer pipe as claimed in claim 1, wherein at least one of the partial pipe shells has an outer surface formed with an elevation at an end thereof.

9. The sewer pipe as claimed in claim 1, further comprising sealing elements arranged between the partial pipe shells.

10. The sewer pipe as claimed in claim 1, wherein the partial pipe shells are made at least partly from plastic.

11. The sewer pipe as claimed in claim 10, wherein the plastic is reinforced with glass fibers.

12. A laying method for a sewer pipe, comprising the steps of connecting an end of a first sewer pipe to a boring device; and drawing the sewer pipe into the ground by means of the boring device.

13. The laying method as claimed in claim 12, wherein after the first sewer pipe has been drawn in, a second said sewer pipe is connected to a free end of the first sewer pipe and is drawn into the ground by means of the boring device and the first sewer pipe.

14. The laying method as claimed in claim 12, wherein the sewer pipe is assembled from partial pipe shells.

15. A laying method for a sewer pipe, comprising the steps of connecting an end of a sewer pipe to a ramming device; and pushing the sewer pine into the ground by the ramming device.

16. A method for producing a sewer pipe string with at least one sewer pipe, comprising the steps of the forming a first sewer pipe from partial pipe shell; placing the first sewer nine in surrounding relationship to one end of a second sewer pipe; and connecting the first and second sewer pine firmly to each other by means of connecting means.

17. The method as claimed in claim 16, wherein at least two of the partial pipe shells of first sewer pipe are connected by a hinge, and further comprising the step of folding the partial pipe shells together so as to embrace the end of the second sewer pipe.

18. A system comprising partial pipe shells, wherein the partial pipe shells are constructed for juxtaposed placement to one another, based on a pipe circumference, to form a pipe; and connecting means for firmly connecting the partial pipe shells to one another.

19. The laying method as claimed in claim 13, and further comprising the step of arranging a seal between the first and second sewer pipes.
